(19) United States
(12) Patent Application Publication
(10) Pub. No.: US 2026/0219771 A1
(43) Pub. Date: Jul. 30, 2026

(54) ENABLING USER GESTURES AT PORTIONS OF GENERATIVE CONTENT FOR INTELLIGENT SELECTION OF GENERATIVE CONTENT BASED ON SUCH PORTIONS

(71) Applicant: GOOGLE LLC, Mountain View, CA (US)

(72) Inventors: Brett Barros, San Mateo, CA (US); Kimberly Harvey, Los Angeles, CA (US)

(21) Appl. No.: 19/041,803

(22) Filed: Jan. 30, 2025

(51) Int. Cl. G06F 3/04842; G06F 3/0481; G06F 3/0488; G06F 40/30; G06F 40/40

(52) U.S. Cl. CPC G06F 3/04842; G06F 3/0481; G06F 3/0488; G06F 40/30; G06F 40/40; G06F 2203/04808

(57) ABSTRACT

Implementations set forth herein relate to an application that can receive gestures at portions of generative content so that generative content can be intelligently selected and/or supplemental generative content can be rendered without requiring another detailed prompt from the user. Each portion of generative content can be identified based on semantic relationship between terms that would comprise the portion. These portions of the generative content can be predetermined or determined in response to receiving input from the user (e.g., a gesture). A particular portion of generative content can be assigned one or more GUI features that can indicate portion(s) of the generative content is available for receiving one or more gestures. When the user directs a gesture at the particular portion of the generative content, one or more models can be utilized to select portion(s) of the generative content and/or to provide supplemental generative content for the user.

### BACKGROUND

Humans may engage in human-to-computer dialogs with interactive software applications referred to herein as “automated assistants” (also referred to as “digital agents,” “chatbots,” “interactive personal assistants,” “intelligent personal assistants,” “assistant applications,” “conversational agents,” etc.). For example, humans (which when they interact with automated assistants may be referred to as “users”) may provide commands and/or requests to an automated assistant using spoken natural language input (i.e., utterances), which may in some cases be converted into text and then processed, and/or by providing textual (e.g., typed) natural language input.

In some instances, a user can interact with an automated assistant or other application in furtherance of receiving generative content about a particular topic. When the user is interested in receiving more granular information about any portion of the generative content, the user may be required to enter a subsequent prompt to the application. As a result, and despite the user in many cases not being particularly familiar with the topic, the user would be required to draft a natural language prompt to request the particular supplemental information they desire. This can be particularly wasteful of time from the perspective of the user and resources from the perspective of the application in terms of processing the supplemental prompt. For example, the user may not receive the desired supplemental information after their first supplemental prompt and would therefore have to draft subsequent prompts until they receive the desired information. In other words, instead of the application taking any proactive steps to supplement without receiving another prompt, the application necessarily wastes computational resources by requiring further prompts. Moreover, supplemental generative content rendered in response to those subsequent prompts may not be relevant to the information desired by the user. Therefore, the resources consumed to generate the irrelevant information for the user would be wasted.

### SUMMARY

Implementations set forth herein relate to an automated assistant and/or other generative application that can receive gesture inputs at semantically distinguished portions of generative content to intelligently select portion(s) of the generative content, create supplemental generative content, and/or cause other action(s) to be performed based on the generative content. A gesture input can include any user input to an interface of a computing device, and the semantically distinguished portions of the generative content can be identified before, during, and/or after receiving the gesture input. In this way, a user can interact with generative content without having to expressly provide additional prompts with significant details for causing additional generative content to be generated and/or to cause other action(s) to be performed with respect to the generative content.

As one non-limiting example, a user can initiate a generative application in furtherance of receiving generative content regarding the latest theories about black holes. The generative content can include various portions of text that can be semantically separated through a variety of different techniques. For example, a certain portion of the generative content can include the term “event horizon”, which may be semantically distinguishable from other terms in the generative content. In some implementations, because the identified term can be semantically distinguished from other terms in the generative content, the application may cause one or more GUI features to be rendered in association with the distinguishable term. Alternatively, or additionally, the application can cause one or more GUI features to be rendered in association with the distinguished term to put the user on notice that one or more gestures can be provided to the application for selecting the distinguished term.

In some implementations, when the user interacts with the distinguished portion of content, additional generative content can be rendered according to the type of gesture that the user provided. For example, one or more particular models can be selected for generating the additional content, and those one or more particular models can be selected based on the type of gesture input received from the user. Alternatively, or additionally, the type of gesture input received can indicate a format or content for a prompt to be provided to one or more models for processing and generating the additional content. For example, a single tap gesture at a distinguished portion of the generative content can result in another prompt being generated and executed for requesting additional information about the selected portion. Alternatively, or additionally, the user can provide a long press gesture at the distinguished term to cause different generative content to be selected and/or cause different additional content to be generated based on a different prompt. For example, a tap gesture can cause a prompt to be generated for soliciting additional content based on the distinguished portion of content and based on a particular temperature setting and/or number of tokens for the prompt. However, when the tap gesture is a long-press gesture, the particular temperature setting can be set so that more detail will be provided, and/or the number of tokens consumed can be increased, relative to the single tap gesture.

In some implementations, the user can provide a two-dimensional gesture or other gesture involving more than a single tap or press at a single location at an interface. For example, a swipe gesture at a particular term that has been distinguished by the generative application can cause different generative content to be selected and/or cause different additional content to be generated based on the distinguished term and any other content associated with the swipe gesture. As one non-limiting example, the swipe gesture can be performed at the term “event horizon” and, per the swipe gesture, can be directed to content above the term “event horizon”. In response, the content above the selected term, as well as the selected term itself, can be utilized for generating a prompt that will be executed for generating the additional content.

In some implementations, additional data can be considered when selecting portion(s) of generative content, determining action(s) to be performed with respect to the selected portion(s) of the generative content, generating the supplemental content that supplements the generative content, etc. The additional data can include, but is not limited to, contextual data, other application data, historical action(s) performed by a user, a personal knowledge graph, and/or any other data that can be associated with an interaction between a user and an application (with prior express permission from the user). For example, information stored with a personal knowledge graph for the user can indicate that the user is particularly interested in biographies of historical figures (e.g., based on data from an audiobook application). Based on this information, and in response to the gesture from the user, the application can provide supplemental generative content that is related to the selected term “event horizon” and any historical figure associated with the term “event horizon” (e.g., Dr. Stephen Hawking). This information can be provided using one or more models that have been trained on large sources of information (e.g., encyclopedias, library books, etc., with prior permission from any creators of those sources). For example, in response to the gesture, the application can generate a prompt that indicates the selected term “event horizon” and user's interest in historical figures. Therefore, when a particular model (e.g., an LLM) is utilized to process the prompt (e.g., “Tell me about historical figures involved in the discovery of blackhole event horizons.”), supplemental generative content of particular interest to the user can be provided.

As described herein, a generative model (GM) can be any sequence-to-sequence based machine learning model capable of generating generative vision data, generative audio data, generative textual data, and/or other forms of generative data, and a large language model (LLM) may be a specific type of GM. Some non-limiting examples of sequence-to-sequence based machine learning models that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models.

The above description is provided as an overview of some implementations of the present disclosure. Further description of those implementations, and other implementations, are described in more detail below.

### BRIEF DESCRIPTION OF THE DRAWINGS

FIG. 1A, FIG. 1B, FIG. 1C, and FIG. 1D illustrate views 100, 120, 140, and 160, respectively, of a user interacting with an application in furtherance of receiving supplemental generative content in response to a gesture provided by the user.

FIG. 2 illustrates a system that can receive gesture inputs at semantically distinguished portions of generative content to create supplemental generative content.

FIG. 3 illustrates a method for receiving gestures at predetermined portions of generative content so that supplemental generative content can be rendered without requiring another detailed prompt from the user.

FIG. 4 is a block diagram of an example computer system.

### DETAILED DESCRIPTION

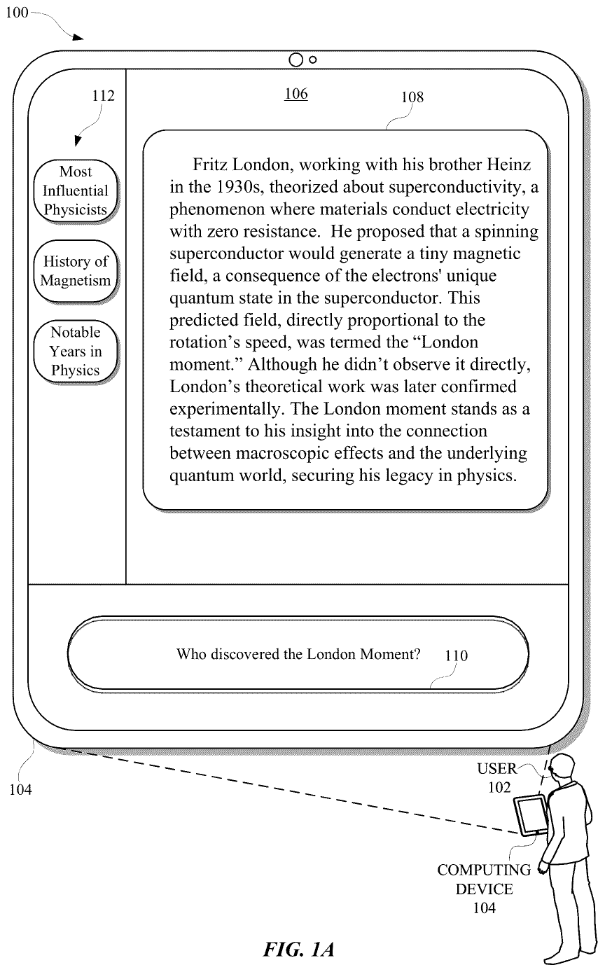

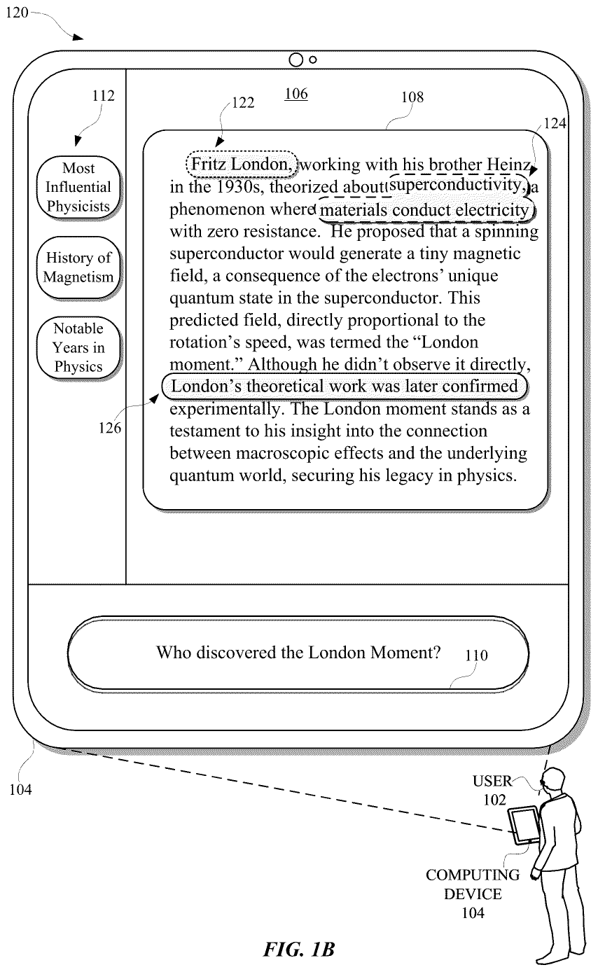

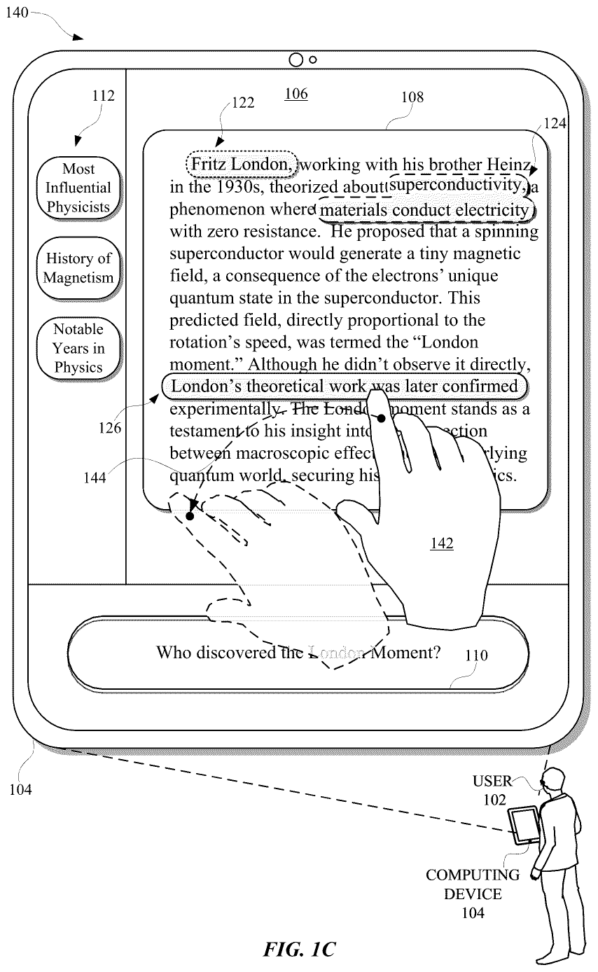

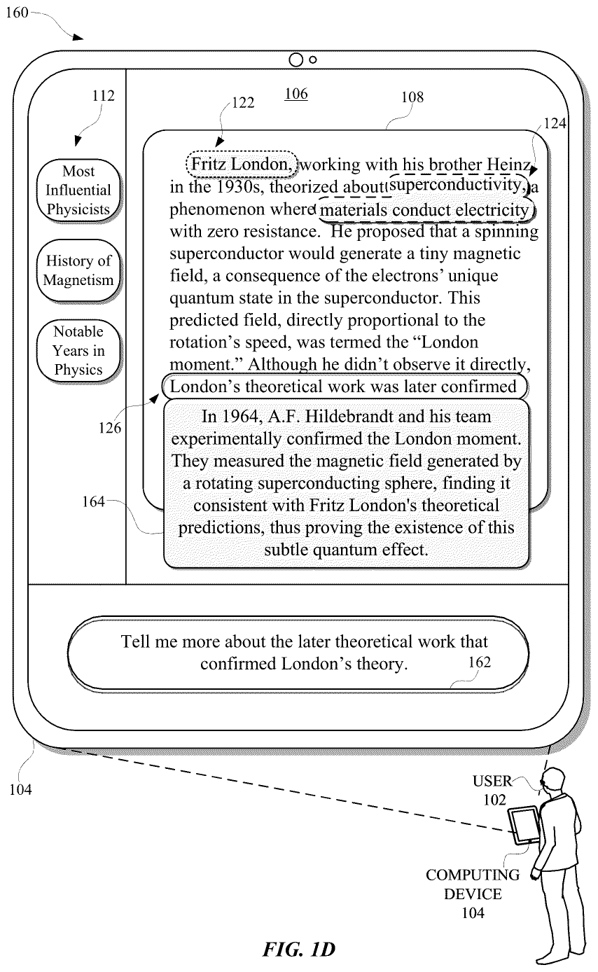

FIG. 1A, FIG. 1B, FIG. 1C, and FIG. 1D illustrate views of a user 102 interacting with an application in furtherance of selecting generative content, causing action(s) to be performed based on selected generative content, and/or receiving supplemental generative content in response to a gesture provided by the user 102. The gesture can be a touch gesture or a non-touch gesture directed to a portion of generative content 108 that is being rendered by the application. For example, and as illustrated in FIG. 1A of view 100, the user 102 can be accessing the application via a computing device 104 in furtherance of receiving generative content. In some instances, the generative content 108 can be provided when the user 102 accesses the application or in response to the user 102 providing a prompt 110 to the application. The prompt 110 can be processed using a large language model (LLM) or other generative model (GM), and other data can also be processed for context so that the user can receive generative content 108 that is most relevant to the user 102. For example, data characterizing prior interactions 112 with the application can be processed with the prompt 110 to generate the generative content 108.

When the generative content 108 is provided by the application, various portions of the generative content can be designated as selectable portions, as illustrated in view 120 of FIG. 1B. For example, the generative content 108 can be processed to identify terms that are semantically related or otherwise have some associations with each other. Data can then be generated to correlate certain terms for designating portions of the generative content as selectable. For example, three different portions of the generative content 108 can be designated as selectable via one or more gestures from the user 102. A first portion 122, a second portion 124, and a third portion 126 can be expressly identified at the display interface 106 of the computing device 104, or may optionally not be expressly identified. For example, one or more GUI features can be rendered in association with each particular portion of the generative content 108. For example, the terms embodying the phrase “superconductivity...materials conduct electricity” can be assigned a GUI feature that indicates the terms a part of the second portion 124. Different GUI features can be rendered with the first portion 122 and the second portion 124.

In some implementations, these portions can be designated as selectable portions when the content is generated and pre-cached at the computing device 104. For example, the one or more GUI features can be stored locally at the computing device 104 and displayed when a gesture or non-gesture input is directed to the generative content 108. In additional or alternative implementations, these portions can be designated as selectable portions at the computing device 104 in response to receiving gesture or non-gesture input is directed to the generative content 108. For example, the one or more GUI features can be determined and rendered using an additional pass across the LLM or GM and in response to receiving the gesture or non-gesture input.

In some implementations, a type of GUI feature that is assigned to a portion of generative content can be indicative of the types of gestures that can be directed to the portion of the generative content. For example, a GUI feature such as color, shape, shading, and/or other static or dynamic features can indicate that the application can be responsive to a tap gesture and a swipe gesture. Alternatively, or additionally, the GUI feature can indicate that the application will be responsive to multiple different types of swipe gestures (e.g., swipe up, swipe down, etc.). In some implementations, the GUI feature that is rendered and/or the types of gestures that are enabled can be based on preprocessing of portions of the generative content. For example, the phrase corresponding to the third portion 126 can be processed in one or more prompts to identify supplemental content before or after the user 102 provides a gesture to the third portion 126. When the supplemental content is determined to be relevant to the user 102 to a threshold degree, a GUI feature can be assigned to the third portion 126 of the generative content 108.

As one example illustrated in view 140 of FIG. 1C, the user 102 can use their hand 142 or other appendage to perform a swipe gesture 144 directed to the third portion 126 of the generative content. In some implementations, the swipe gesture 144 performed by the user 102 in FIG. 1C can be a swipe-down gesture that indicates the user 102 would like another similar prompt to be created and executed for providing supplemental content. This can be compared to a swipe-up gesture, which can indicate the user 102 would like the third portion 126 of generative content 108 to be selected, to be the subject of a different prompt and/or executed by one or more different models (e.g., because the user is swiping away from the previous prompt 110 when swiping up), and/or to be the subject of another action.

In response to the swipe gesture 144, another prompt 162 can optionally be generated and processed by one or more models and/or another action can optionally be performed by one or more of the models or another component. For example, and as illustrated in view 160 of FIG. 1D, the other prompt 162 can be a request for additional information regarding the terms of the third portion 126 of generative content 108. In some implementations, the other prompt 162 can be generated based on the third portion 126, as well as other data such as contextual data, personal knowledge graph data, and other data associated with previous interactions between the user 102 and the application. For example, because the prior interactions 112 indicate that the user 102 has been interested in historical figures, the other prompt 162 can be generated to focus on terms identifying a person's name (“London's theory”) rather than the meaning of other terms (“Theoretical work”). As a result, the other prompt 162 can be generated and executed to provide the supplemental content 164 for rending in association with the third portion 126 of the generative content 108. By allowing the user 102 to bypass expressly drafting their own prompt to receive supplemental content, trial and error associated with manually generating and executing prompts can be avoided. This can preserve significant computational resources (e.g., process bandwidth at supporting servers, and electricity consumption) that might otherwise be wasted processing manual prompts that are created by the user 102 but that do not result in the desired supplemental content. Rather, the user 102 can simply perform a gesture, that is less time consuming than drafting a manual prompt, to receive supplemental content 164 that is more desirable to the user 102. Although not depicted, other action(s) can be performed based on the swipe gesture 144, such as an image or video generation action that is based on content subject to the swipe gesture 144, a “more concise” or “more detail” generation action that is based on content subject to the swipe gesture 144, and/or other actions optionally using other GMs or applications accessible by the computing device 104.

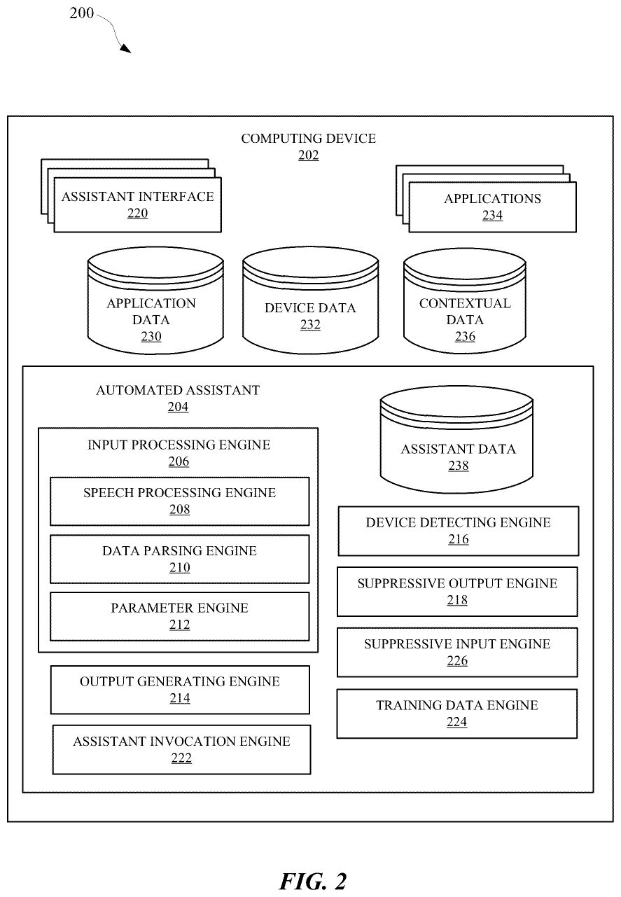

FIG. 2 illustrates a system 200 that can receive gesture inputs at semantically distinguished portions of generative content to create supplemental generative content. For example, the automated assistant 204 can operate as part of an assistant application that is provided at one or more computing devices, such as a computing device 202 and/or a server device. A user can interact with the automated assistant 204 via assistant interface(s) 220, which can be a microphone, a camera, a touch screen display, a user interface, and/or any other apparatus capable of providing an interface between a user and an application. For instance, a user can initialize the automated assistant 204 by providing a verbal, textual, and/or a graphical input to an assistant interface 220 to cause the automated assistant 204 to initialize one or more actions (e.g., provide data, control a peripheral device, access an agent, generate an input and/or an output, etc.). Alternatively, the automated assistant 204 can be initialized based on processing of contextual data 236 using one or more trained machine learning models. The contextual data 236 can characterize one or more features of an environment in which the automated assistant 204 is accessible, and/or one or more features of a user that is predicted to be intending to interact with the automated assistant 204. The computing device 202 can include a display device, which can be a display panel that includes a touch interface for receiving touch inputs and/or gestures for allowing a user to control applications 234 of the computing device 202 via the touch interface. In some implementations, the computing device 202 can lack a display device, thereby providing an audible user interface output, without providing a graphical user interface output. Furthermore, the computing device 202 can provide a user interface, such as a microphone, for receiving spoken natural language inputs from a user. In some implementations, the computing device 202 can include a touch interface and can be void of a camera, but can optionally include one or more other sensors.

The computing device 202 and/or other third party client devices can be in communication with a server device over a network, such as the internet. Additionally, the computing device 202 and any other computing devices can be in communication with each other over a local area network (LAN), such as a Wi-Fi network. The computing device 202 can offload computational tasks to the server device in order to conserve computational resources at the computing device 202. For instance, the server device can host the automated assistant 204, and/or computing device 202 can transmit inputs received at one or more assistant interfaces 220 to the server device. However, in some implementations, the automated assistant 204 can be hosted at the computing device 202, and various processes that can be associated with automated assistant operations can be performed at the computing device 202.

In various implementations, all or less than all aspects of the automated assistant 204 can be implemented on the computing device 202. In some of those implementations, aspects of the automated assistant 204 are implemented via the computing device 202 and can interface with a server device, which can implement other aspects of the automated assistant 204. The server device can optionally serve a plurality of users and their associated assistant applications via multiple threads. In implementations where all or less than all aspects of the automated assistant 204 are implemented via computing device 202, the automated assistant 204 can be an application that is separate from an operating system of the computing device 202 (e.g., installed “on top” of the operating system)—or can alternatively be implemented directly by the operating system of the computing device 202 (e.g., considered an application of, but integral with, the operating system).

In some implementations, the automated assistant 204 can include an input processing engine 206, which can employ multiple different modules for processing inputs and/or outputs for the computing device 202 and/or a server device. For instance, the input processing engine 206 can include a speech processing engine 208, which can process audio data received at an assistant interface 220 to identify the text embodied in the audio data. The audio data can be transmitted from, for example, the computing device 202 to the server device in order to preserve computational resources at the computing device 202. Additionally, or alternatively, the audio data can be exclusively processed at the computing device 202.

The process for converting the audio data to text can include a speech recognition algorithm, which can employ neural networks, and/or statistical models for identifying groups of audio data corresponding to words or phrases. The text converted from the audio data can be parsed by a data parsing engine 210 and made available to the automated assistant 204 as textual data that can be used to generate and/or identify command phrase(s), intent(s), action(s), slot value(s), and/or any other content specified by the user. In some implementations, output data provided by the data parsing engine 210 can be provided to a parameter engine 212 to determine whether the user provided an input that corresponds to a particular intent, action, and/or routine capable of being performed by the automated assistant 204 and/or an application or agent that is capable of being accessed via the automated assistant 204. For example, assistant data 238 can be stored at the server device and/or the computing device 202, and can include data that defines one or more actions capable of being performed by the automated assistant 204, as well as parameters necessary to perform the actions. The parameter engine 212 can generate one or more parameters for an intent, action, and/or slot value, and provide the one or more parameters to an output generating engine 214. The output generating engine 214 can use the one or more parameters to communicate with an assistant interface 220 for providing an output to a user, and/or communicate with one or more applications 234 for providing an output to one or more applications 234.

In some implementations, the automated assistant 204 can be an application that can be installed “on-top of” an operating system of the computing device 202 and/or can itself form part of (or the entirety of) the operating system of the computing device 202. The automated assistant application includes, and/or has access to, on-device speech recognition, on-device natural language understanding, and on-device fulfillment. For example, on-device speech recognition can be performed using an on-device speech recognition module that processes audio data (detected by the microphone(s)) using an end-to-end speech recognition machine learning model stored locally at the computing device 202. The on-device speech recognition generates recognized text for a spoken utterance (if any) present in the audio data. Also, for example, on-device natural language understanding (NLU) can be performed using an on-device NLU module that processes recognized text, generated using the on-device speech recognition, and optionally contextual data, to generate NLU data. In some implementations, on-device speech recognition, on-device NLU, and/or on-device fulfillment can be omitted. In these implementations, on-device generative model(s) can be utilized in the same or similar manner to generate the same or similar data and at least due to their multimodal nature described herein.

NLU data can include intent(s) that correspond to the spoken utterance and optionally parameter(s) (e.g., slot values) for the intent(s). On-device fulfillment can be performed using an on-device fulfillment module that utilizes the NLU data (from the on-device NLU), and optionally other local data, to determine action(s) to take to resolve the intent(s) of the spoken utterance (and optionally the parameter(s) for the intent). This can include determining local and/or remote responses (e.g., answers) to the spoken utterance, interaction(s) with locally installed application(s) to perform based on the spoken utterance, command(s) to transmit to internet-of-things (IoT) device(s) (directly or via corresponding remote system(s)) based on the spoken utterance, and/or other resolution action(s) to perform based on the spoken utterance. The on-device fulfillment can then initiate local and/or remote performance/execution of the determined action(s) to resolve the spoken utterance.

In various implementations, remote speech processing, remote NLU, remote fulfillment, and/or remote GM(s) can at least selectively be utilized. For example, recognized text can at least selectively be transmitted to remote automated assistant component(s) for remote NLU, remote fulfillment, and/or remote processing by remote GM(s). For instance, the recognized text can optionally be transmitted for remote performance in parallel with on-device performance, or responsive to failure of on-device NLU, on-device fulfillment, and/or on-device processing by on-device GM(s). However, on-device speech processing, on-device NLU, on-device fulfillment, on-device processing by GM(s), and/or on-device execution can be prioritized at least due to the latency reductions they provide when resolving a spoken utterance (due to no client-server roundtrip(s) being needed to resolve the spoken utterance). Further, on-device functionality can be the only functionality that is available in situations with no or limited network connectivity.

In some implementations, the computing device 202 can include one or more applications 234 which can be provided by a third-party entity that is different from an entity that provided the computing device 202 and/or the automated assistant 204. An application state engine of the automated assistant 204 and/or the computing device 202 can access application data 230 to determine one or more actions capable of being performed by one or more applications 234, as well as a state of each application of the one or more applications 234 and/or a state of a respective device that is associated with the computing device 202. A device state engine of the automated assistant 204 and/or the computing device 202 can access device data 232 to determine one or more actions capable of being performed by the computing device 202 and/or one or more devices that are associated with the computing device 202. Furthermore, the application data 230 and/or any other data (e.g., device data 232) can be accessed by the automated assistant 204 to generate contextual data 236, which can characterize a context in which a particular application 234 and/or device is executing, and/or a context in which a particular user is accessing the computing device 202, accessing an application 234, and/or any other device or module.

While one or more applications 234 are executing at the computing device 202, the device data 232 can characterize a current operating state of each application 234 executing at the computing device 202. Furthermore, the application data 230 can characterize one or more features of an executing application 234, such as content of one or more graphical user interfaces being rendered at the direction of one or more applications 234. Alternatively, or additionally, the application data 230 can characterize an action schema, which can be updated by a respective application and/or by the automated assistant 204, based on a current operating status of the respective application. Alternatively, or additionally, one or more action schemas for one or more applications 234 can remain static, but can be accessed by the application state engine in order to determine a suitable action to initialize via the automated assistant 204.

The computing device 202 can further include an assistant invocation engine 222 that can use one or more trained machine learning models to process application data 230, device data 232, contextual data 236, and/or any other data that is accessible to the computing device 202. The assistant invocation engine 222 can process this data in order to determine whether or not to wait for a user to explicitly speak an invocation phrase to invoke the automated assistant 204, or consider the data to be indicative of an intent by the user to invoke the automated assistant—in lieu of requiring the user to explicitly speak the invocation phrase. For example, the one or more trained machine learning models can be trained using instances of training data that are based on scenarios in which the user is in an environment where multiple devices and/or applications are exhibiting various operating states. The instances of training data can be generated in order to capture training data that characterizes contexts in which the user invokes the automated assistant and other contexts in which the user does not invoke the automated assistant. When the one or more trained machine learning models are trained according to these instances of training data, the assistant invocation engine 222 can cause the automated assistant 204 to detect, or limit detecting, spoken invocation phrases from a user based on features of a context and/or an environment. Additionally, or alternatively, the assistant invocation engine 222 can cause the automated assistant 204 to detect, or limit detecting for one or more assistant commands from a user based on features of a context and/or an environment. In some implementations, the assistant invocation engine 222 can be disabled or limited based on the computing device 202 detecting an assistant suppressing output from another computing device. In this way, when the computing device 202 is detecting an assistant suppressing output, the automated assistant 204 will not be invoked based on contextual data 236—which would otherwise cause the automated assistant 204 to be invoked if the assistant suppressing output was not being detected.

In some implementations, the system 200 can include a selectable portion engine 216 that can identify and/or define selectable portions within generative content provided by the automated assistant 204 and/or application 234. In some implementations, the selectable portions can correspond to semantically distinguishable regions or objects within the content for enabling user interaction with the generative content and/or those portions. In some implementations, the selectable portion engine 216 can employ image segmentation, object recognition, and/or natural language processing techniques to identify said selectable portions. For example, encodings or embeddings can be generated for one or more portions of generative content for determining whether the portions exhibit a threshold similarity to each other. When the portions exhibit the threshold similarity, the selectable portion engine 216 can communicate data to a GUI feature engine 224 of the system 200.

In some implementations, the GUI feature engine 224 can manage the graphical user interface (GUI) features that can be rendered in association with each selectable portion and/or for optionally distinguishing each selectable portion. The GUI feature engine 224 can receive the data from the selectable portion engine 216 can determine the particular features that will be utilized for distinguishing each selectable portion that has been identified from the generative content. The GUI feature engine 224 can optionally provide visual feedback to the user during interaction with the generative content, and can also determine to distinguish GUI features of supplemental content. In some implementations, the application providing the generative content can be responsive to gestures at any of the selectable portions and generate gesture data that characterizes a received gesture and/or the selected portion of the generative content. In response, the GUI feature engine 224 can optionally indicate that the gesture has been received at the portion of the generative content that the gesture was directed to.

In some implementations, the system 200 can include a gesture data engine 219 that can interact with the input processing engine 206 to generate gesture data that characterizes gesture input received from a user. The gesture data can characterize features of the user input gesture, including gesture type, location within a selectable portion, coordinate information (e.g., for a single-touch gesture, multi-touch gesture, non-touch gesture, etc.), and/or temporal characteristics. The gesture data can be communicated to a generative content engine 226 of the system 200, which can then use the gesture data to provide generative content based on the gesture data.

In some implementations, the generative content engine 226 can generate and/or modify generative content and/or cause other action(s) to be performed. For example, the generative content engine 226 can provide generative content in response to an initial prompt and/or in response to a gesture input from the user. The generative content can be provided to supplement or replace any existing content being rendered by the system 200, without requiring the user to draft a natural language prompt or otherwise expressly type out another prompt. The generative content engine 226 can employ various content generation techniques that can leverage different types of trained machine learning models to develop content. In some implementations, a large language model (LLM) or other generative model (GM) can be utilized to generate a prompt from a selected portion of the generative content that can then be processed for generating supplemental content, generate instructions to transmit to another application, agent, extension, and/or device via an application programming interface (API), and/or to cause other actions to be performed. Alternatively, or additionally, the supplemental generative content can be generated without necessarily requiring a detailed, natural language prompt to be generated by the system 200 after receiving the gesture. In some implementations, GUI features indicative of selectable content and/or supplemental generative content can be generated prior to receiving any gesture, thereby limiting any perceived latency between receiving the gesture to intelligently selecting the content and/or rendering the supplemental content. Furthermore, this can also eliminate the need for the user to expressly draft a detailed, natural language prompt for supplemental content, thereby further preserving resources of the system 200 and any other affected devices and applications.

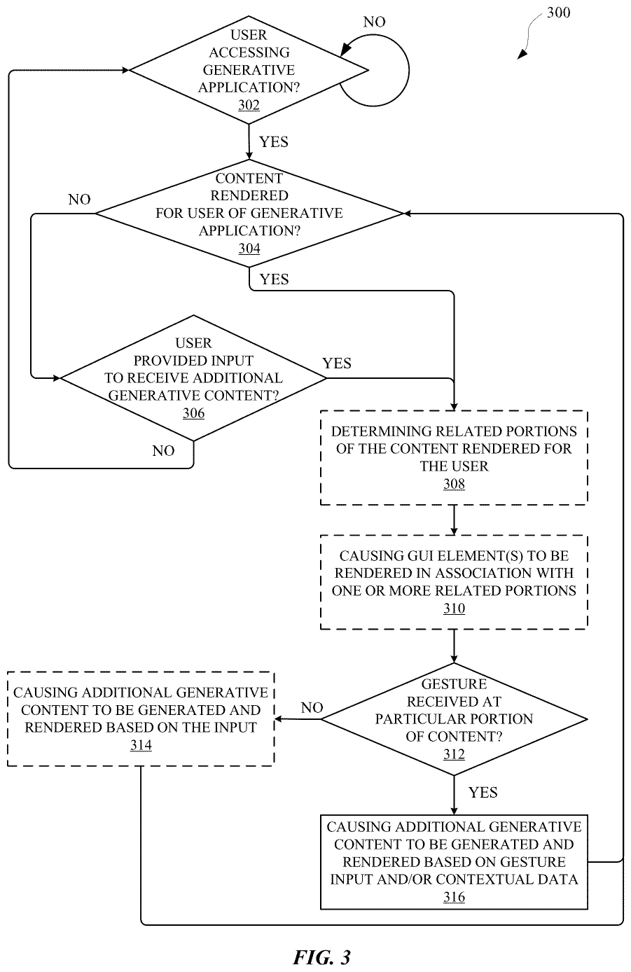

FIG. 3 illustrates a method 300 for receiving gestures at predetermined portions of generative content so that supplemental generative content can be rendered without requiring another detailed prompt from the user. The method 300 can be performed by one or more devices, applications, and/or any other apparatus or module capable of providing access to an automated assistant. The method 300 can include an operation 302 of determining whether a user is accessing a generative application, assistant application, or other application that can provide generative content. For example, the user can access an application for receiving generative content to supplement a research project they are participating in. When the user selects the application to initially open the application, generative content can be rendered by default or the application can await a prompt from the user before providing generative content. The method 300 can proceed from the operation 302 to an operation 304.

The operation 304 can include determining whether content is being rendered for a user of the generative application. For example, when generative content is rendered by default, or the user has already interacted with the application, there may be generative content already rendered at a display interface for the application. In furtherance of the project example, a prior chat window may be rendered upon accessing the application, and the chat window may include generative content related to the project. When the project relates to a business plan that the user is developing for a graduate degree program, the generative content may describe what is included in a typical business plan. For example, a portion of the generative content can describe how a business plan should include explanations that can assist the average person with understanding certain technology that might be promoted by the business. When generative content is rendered for the user at the operation 304, the method 300 can proceed from the operation 304 to an operation 308. However, if generative content is not being rendered for the user, the method can proceed from the operation 304 to an operation 306. In some implementations, generative content can refer to content that is at least partially generated using one or more trained machine learning models, and/or content that is generated in response to a request from the user for the content.

The operation 306 can include determining whether the user provided an input to receive additional generative content. The user can provide input to receive additional generative content by providing an input to an interface of a computing device that is providing access to the application. For example, the user can provide a natural language input that is typed at a text field for the generative application, and then submit the input to the application. Alternatively, input to the application can be provided as audio, video, touch input and/or any other input that can be provided by a user to an application. In response to receiving the input, the additional generative content can be rendered for the user at a display interface of a computing device. The method 300 can then proceed from the operation 306 to the optional operation 308, the optional operation 310, and/or the operation 312.

The optional operation 308 can include determining any related portions of the content rendered for the user. Each related portion can include one or more terms, such as words, characters, symbols, and/or other data that conveys some information to the user. Two or more portions of generative content can be identified as related when each portion shares one or more related features. For example, semantic similarities between two or more portions can be determined, and optionally ranked, in furtherance of determining whether to generate data that characterizes a particular set of related portions. When two or more portions are determined to be related, optionally to a threshold degree, data can be generated for characterizing those particular portions, and that data can then be utilized to generate GUI elements at the operation 310.

In some implementations, determining whether two or more portions of generative content are related can include processing various portions of the generative content and generating embeddings for those portions. The embeddings can then be mapped to a latent space for determining whether certain portions of the generative content are related. For instance, two or more embeddings may be within a threshold distance of each other in the latent space, thereby indicating those terms are related to each other. Alternatively, or additionally, information characterizing interests of the user and/or a personal knowledge graph of the user can also be mapped to the latent space with prior permission from the user to determine whether certain related portions are also of interest to the user. When certain portions are determined to be related, the method 300 can optionally proceed from the operation 308 to the operation 310.

The operation 310 can include causing GUI elements to be rendered in association with the one or more portions of generative content that were determined to be related. For example, when one or more portions of text, portions of an image, portions of video, and/or portions of audio are determined to be related, GUI elements and/or other interface outputs can be rendered for the user. These interface outputs can be provided to put the user on notice of an ability of the application to receive further inputs, such as input gestures, for invoking the application to provide supplemental generative content. The supplemental generative content can be generated using data characterizing the portions of related content that the user's input was directed to. For example, a prompt can be generated based on the selected related portions and then executed using one or more trained machine learning models. The generative content that is created from executing the prompt can be provided as supplemental generative content for the user.

In some implementations, the interface outputs that are rendered for indicating related portions of generative content can include different GUI features that distinguish the identified related portions from other portions of the generative content. For example, features of a font of the related portions of generative content can be modified to distinguish those related portions from the other portions of generative content. Alternatively, or additionally, GUI features surrounding the related portions of generative content can be modified to distinguish the related portions from the other portions of generative content. Alternatively, or additionally, static and/or dynamic features of the related portions of generative content can be modified and/or added to distinguish those related portions from the other portions of generative content. When the GUI elements and/or other interface output features are rendered in association with the related portions, the method 300 can optionally proceed from the operation 310 to an operation 312.

The operation 312 can include determining whether a gesture or other user input was received at the particular portion of generative content, such as the related portion of generative content determined by the application or other generative application. In some implementations, any gesture that a user can provide to an application can also be received as a related portion of generative content. For example, a tap gesture, swipe gesture, long press gesture, two-point gesture, multi-point gesture, and/or other type of gesture that can be received at one or more interfaces of the computing device, can be utilized to interact with a portion of the generative content that is estimated to be of interest to the user for receiving supplemental generative content. In some implementations, portions of generative content that may be of interest to the user can include those that are determined to exhibit a threshold relevance to certain topics of interest to the user, with prior permission from the user. These portions of the generative content can be designated by the application, and can include one or more terms, characters, images, videos, and/or other portions of content. When a gesture input or other input is determined to have been received by the application and directed to a particular portion of generative content, the method 300 can proceed from the operation 312 to an operation 316. Otherwise, when the application is idle or otherwise the user has not provided an input gesture directed to a portion of the generative content, the method 300 can proceed from the operation 312 to an operation 314.

The operation 314 can include causing additional generative content to be generated and rendered based on an input from the user, such as the input provided at the operation 306 and/or any other input the user provided to the application. The operation 314 can be an optional operation depending on how the application determines whether a user has expressly provided an input to the application. The operation 316 can include causing additional generative content to be generated and rendered based on the gesture input and/or other contextual data associated with the user and/or the application. In some implementations, the generative content can be determined prior to the user providing the input directed to the portion of the generative content. This can be accomplished by pre-processing portions of the generative content that the application determines or otherwise estimates the user to be interested in, with prior permission from the user. In this way, latency that may be exhibited between the user providing the gesture input, and the supplemental content being rendered, can be mitigated.

In some implementations, the supplemental generative content that is generated prior to the user providing the gesture input can be utilized for distinguishing certain portions of the generative content from other portions of the generative content. In this way, when the pre-generated supplemental generative content for a particular portion of existing generative content is estimated to not be within a threshold relevance or interest to the user (with prior permission from the user), the application can bypass distinguishing that particular portion of the generative content from the other portions. In some implementations, supplemental generative content can be simultaneously rendered with the existing generative content or provided in place of the selected portion of the generative content. Alternatively, or additionally, the selected portion of the generative content can be replaced with an indication GUI element that the user selected the selected portion, and the supplemental generative content can be rendered in association with that indication GUI element. The method 300 can then proceed from the operation 316 to the operation 304, and/or another suitable operation.

Although the method 300 is described with respect to the operation 316 including causing additional generative content to be generated and rendered based on the gesture input and/or other contextual data associated with the user and/or the application, it should be understood that is for the sake of example and is not meant to be limiting. For example, in additional or alternative implementations, other action(s) can be performed and optionally based on the particular portion of content that is selected. For instance, the particular portion of the content can be associated with various tasks, such as document generation tasks, image generation tasks, video generation tasks, controlling other applications, controlling other computing devices and/or Internet-of-Things (IoT) devices, and so on.

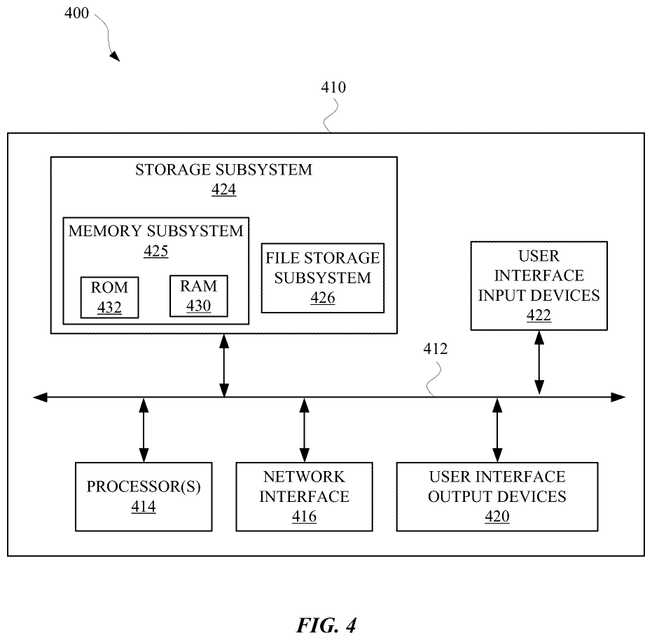

FIG. 4 is a block diagram 400 of an example computer system 410. Computer system 410 typically includes at least one processor 414 which communicates with a number of peripheral devices via bus subsystem 412. These peripheral devices may include a storage subsystem 424, including, for example, a memory 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 300, and/or to implement one or more of system 200, computing device 104, automated assistant, and/or any other application, device, apparatus, and/or module discussed herein.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, a method implemented by processor(s) is provided, and includes causing generative content to be rendered at a display interface of a computing device that is providing access to a generative application. The generative content is rendered in response to an interaction between a user and the computing device. The method further includes identifying, based on the generative content, one or more related portions of the generative content as a selectable portion of the generative content. The selectable portion of the generative content corresponds to less than an entirety of the generative content. The method further includes causing one or more graphical user interface (GUI) features to be rendered in association with the selectable portion of the generative content. The one or more GUI features are rendered at the display interface of the computing device for indicating that the selectable portion is available for the user to interact with. The method further includes determining that the user provided an input to the computing device in furtherance of interacting with the selectable portion of the generative content, and generating additional generative content based on the one or more related portions of the generative content. The additional generative content is different from the generative content rendered at the display interface of the computing device. The method further includes causing the additional generative content to be rendered at the display interface in response to the user interacting with the selectable portion of the generative content.

These and other implementations of technology disclosed herein can optionally include one or more of the following features.

In some implementations, generating the additional generative content based on the one or more related portions of the generative content can include: generating gesture data that characterizes the input provided by the user, and generating a prompt based on the gesture data and the one or more related portions of the generative content.

In some versions of those implementations, the gesture data can further characterize a physical motion of an appendage of the user when the user provided the input, and the prompt can include natural language content corresponding to a particular portion of the selectable portion of the generative content.

In some implementations, generating the additional generative content based on the one or more related portions of the generative content can include: determining that the input corresponds to a particular type of input gesture, selecting one or more particular generative models based on the particular type of input gesture, and causing the selectable portion of the generative content to be processed using the one or more particular generative models. The additional generative content can be generated based on processing the selectable portion using the one or more particular generative models.

In some implementations, identifying the one or more related portions of the generative content as the selectable portion of the generative content can include determining that at least two different portions of the generative content embody one or more semantic similarities. The one or more GUI features can include a GUI feature rendered in association with the at least two separate portions of the generative content.

In some implementations, identifying the one or more related portions of the generative content as the selectable portion of the generative content can include determining that at least two different portions of the generative content relate to contextual data associated with the user. The one or more GUI features can include a GUI feature rendered in association with a particular portion of the generative content.

In some implementations, determining that the user provided an input to the computing device can include detecting a touch gesture that begins at a first position and terminates at a second position of the display interface. The first position can correspond to a particular related portion of the one or more related portions of the generative content, and the additional generative content can be generated based at least on the particular related portion of the one or more related portions.

In some implementations, determining that the user provided an input to the computing device can include determining that the user provided a long-press gesture at the display interface of the computing device. The additional generative content can be generated based at least on a duration of the long-press gesture.

In some implementations, determining that the user provided an input to the computing device can include determining that the user provided a multi-touch gesture at two distinct positions on the display interface of the computing device. The two distinct positions can correspond to two particular related portions of the one or more related portions of the generative content, and the additional generative content can be generated based on the two particular related portions.

In some implementations, the method can further include generating selectable content data that characterizes the one or more GUI features and/or the selectable portion of the generative content. The selectable content data can be generated prior to the user providing the input to the computing device.

In some versions of those implementations, the selectable data can be stored locally at the computing device in response to the interaction between the user and the computing device.

In additional or alternative versions of those implementations, generating the additional generative content can be performed in response to the interaction between the user and the computing device, and prior to the user providing the input to the computing device.

In some implementations, a method implemented by processor(s) is provided, and includes causing generative content to be rendered at a display interface of a computing device that is providing access to a generative application. The generative content is rendered by the generative application and/or a separate application. The method further includes determining that a user provided a particular type of input gesture to the computing device in furtherance of interacting with a particular portion of the generative content. The particular portion of the generative content corresponds to less than an entirety of the generative content, and the generative application is responsive to different types of input gestures for providing different generative content for the user. The method further includes generating additional generative content based on the particular portion of the generative content and the particular type of input gesture provided by the user. The additional generative content is different from the generative content rendered at the display interface of the computing device, and the additional generative content is generated using one or more generative models. The method further includes causing the additional generative content to be rendered at the display interface in response to the user interacting with the particular portion of the generative content via the particular type of input gesture.

These and other implementations of technology disclosed herein can optionally include one or more of the following features.

In some implementations, determining that the user provided the particular type of input gesture can include determining coordinate data for a user input gesture relative to the generative content rendered at the display interface. The coordinate data can characterize a boundary for the user input gesture relative to the generative content rendered at the display interface.

In some implementations, generating the additional generative content can include selecting the one or more generative models, from a set of generative models, according to the particular type of input gesture provided by the user.

In some implementations, determining that the user provided the particular type of input gesture can include determining a path traced at an interface of the computing device during performance of an input gesture from the user. One or more features of the additional generative content can be based on the path traced at the interface of the computing device.

In some implementations, a method implemented by processor(s) is provided, and includes causing generative content to be rendered at a display interface of a computing device that is providing access to a generative application. The generative content is rendered by the generative application and/or a separate application. The method further includes determining that a user provided a particular type of input gesture to the computing device in furtherance of interacting with a particular portion of the generative content. The particular portion of the generative content corresponds to less than an entirety of the generative content, and the generative application is responsive to different types of input gestures for providing different generative content for the user. The method further includes determining, based on the particular type of input gesture, terms associated with the particular portion of the generative content. The one or more terms correspond to less than an entirety of terms in the generative content. The method further includes generating additional generative content based on a prompt that includes the terms. The additional generative content is different from the generative content rendered at the display interface of the computing device, and the additional generative content is generated using one or more generative models. The method further includes causing the additional generative content to be rendered at the display interface in response to the user interacting with the particular portion of the generative content via the particular type of input gesture.

These and other implementations of technology disclosed herein can optionally include one or more of the following features.

In some implementations, determining the terms associated with the particular portion of the generative content can include determining that a semantic similarity between the terms provided in the generative content satisfies a threshold similarity.

In some implementations, the method can further include generating the prompt based on the terms and a previous prompt that was executed to generate the generative content provided at the display interface. The prompt can be executed using the one or more generative models.

In some versions of those implementations, the prompt can be further generated based on contextual data and/or personal knowledge graph information associated with the user.

Other implementations may include a non-transitory computer readable storage medium storing instructions executable by one or more processors (e.g., central processing unit(s) (CPU(s)), graphics processing unit(s) (GPU(s)), and/or tensor processing unit(s) (TPU(s)) to perform a method such as one or more of the methods described above and/or elsewhere herein. Yet other implementations may include a system of one or more computers that include one or more processors operable to execute stored instructions to perform a method such as one or more of the methods described above and/or elsewhere herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

We claim:

1. A method implemented by one or more processors, the method comprising:
causing generative content to be rendered at a display interface of a computing device that is providing access to a generative application,
wherein the generative content is rendered in response to an interaction between a user and the computing device;
identifying, based on the generative content, one or more related portions of the
generative content as a selectable portion of the generative content,
wherein the selectable portion of the generative content corresponds to less than an entirety of the generative content;
causing one or more graphical user interface (GUI) features to be rendered in association with the selectable portion of the generative content,
wherein the one or more GUI features are rendered at the display interface of the computing device for indicating that the selectable portion is available for the user to interact with;
determining that the user provided an input to the computing device in furtherance of interacting with the selectable portion of the generative content;
generating additional generative content based on the one or more related portions of the generative content,
wherein the additional generative content is different from the generative content rendered at the display interface of the computing device; and
causing the additional generative content to be rendered at the display interface in response to the user interacting with the selectable portion of the generative content.

2. The method of claim 1, wherein generating the additional generative content based on the one or more related portions of the generative content includes:
generating gesture data that characterizes the input provided by the user, and
generating a prompt based on the gesture data and the one or more related portions of the generative content.

3. The method of claim 2,
wherein the gesture data further characterizes a physical motion of an appendage of the user when the user provided the input, and
wherein the prompt includes natural language content corresponding to a particular portion of the selectable portion of the generative content.

4. The method of claim 1, wherein generating the additional generative content based on the one or more related portions of the generative content includes:
determining that the input corresponds to a particular type of input gesture,
selecting one or more particular generative models based on the particular type of input gesture, and
causing the selectable portion of the generative content to be processed using the one or more particular generative models,
wherein the additional generative content is generated based on processing the selectable portion using the one or more particular generative models.

5. The method of claim 1, wherein identifying the one or more related portions of the generative content as the selectable portion of the generative content includes:
determining that at least two different portions of the generative content embody one or more semantic similarities,
wherein the one or more GUI features include a GUI feature rendered in association with the at least two separate portions of the generative content.

6. The method of claim 1, wherein identifying the one or more related portions of the generative content as the selectable portion of the generative content includes:
determining that at least two different portions of the generative content relate to contextual data associated with the user,
wherein the one or more GUI features include a GUI feature rendered in association with a particular portion of the generative content.

7. The method of claim 1, wherein determining that the user provided an input to the computing device includes:
detecting a touch gesture that begins at a first position and terminates at a second position of the display interface,
wherein the first position corresponds to a particular related portion of the one or more related portions of the generative content, and the additional generative content is generated based at least on the particular related portion of the one or more related portions.

8. The method of claim 1, wherein determining that the user provided an input to the computing device includes:
determining that the user provided a long-press gesture at the display interface of the computing device,
wherein the additional generative content is generated based at least on a duration of the long-press gesture.

9. The method of claim 1, wherein determining that the user provided an input to the computing device includes:
determining that the user provided a multi-touch gesture at two distinct positions on the display interface of the computing device,
wherein the two distinct positions correspond to two particular related portions of the one or more related portions of the generative content, and the additional generative content is generated based on the two particular related portions.

10. The method of claim 1, further comprising:
generating selectable content data that characterizes the one or more GUI features and/or the selectable portion of the generative content,
wherein the selectable content data is generated prior to the user providing the input to the computing device.

11. The method of claim 10, wherein the selectable data is stored locally at the computing device in response to the interaction between the user and the computing device.

12. The method of claim 10, wherein generating the additional generative content is performed in response to the interaction between the user and the computing device, and prior to the user providing the input to the computing device.

13. A method implemented by one or more processors, the method comprising:
causing generative content to be rendered at a display interface of a computing device that is providing access to a generative application,
wherein the generative content is rendered by the generative application and/or a separate application;
determining that a user provided a particular type of input gesture to the computing device in furtherance of interacting with a particular portion of the generative content,
wherein the particular portion of the generative content corresponds to less than an entirety of the generative content, and
wherein the generative application is responsive to different types of input gestures for providing different generative content for the user;
generating additional generative content based on the particular portion of the generative content and the particular type of input gesture provided by the user,
wherein the additional generative content is different from the generative content rendered at the display interface of the computing device, and the additional generative content is generated using one or more generative models; and
causing the additional generative content to be rendered at the display interface in response to the user interacting with the particular portion of the generative content via the particular type of input gesture.

14. The method of claim 13, wherein determining that the user provided the particular type of input gesture includes:
determining coordinate data for a user input gesture relative to the generative content rendered at the display interface,
wherein the coordinate data characterizes a boundary for the user input gesture relative to the generative content rendered at the display interface.

15. The method of claim 13, wherein generating the additional generative content includes:
selecting the one or more generative models, from a set of generative models, according to the particular type of input gesture provided by the user.

16. The method of claim 13, wherein determining that the user provided the particular type of input gesture includes:
determining a path traced at an interface of the computing device during performance of an input gesture from the user,
wherein one or more features of the additional generative content are based on the path traced at the interface of the computing device.

17. A method implemented by one or more processors, the method comprising:
causing generative content to be rendered at a display interface of a computing device that is providing access to a generative application,
wherein the generative content is rendered by the generative application and/or a separate application;
determining that a user provided a particular type of input gesture to the computing device in furtherance of interacting with a particular portion of the generative content,
wherein the particular portion of the generative content corresponds to less than an entirety of the generative content, and
wherein the generative application is responsive to different types of input gestures for providing different generative content for the user;
determining, based on the particular type of input gesture, terms associated with the particular portion of the generative content,
wherein the one or more terms correspond to less than an entirety of terms in the generative content;
generating additional generative content based on a prompt that includes the terms,
wherein the additional generative content is different from the generative content rendered at the display interface of the computing device, and the additional generative content is generated using one or more generative models; and
causing the additional generative content to be rendered at the display interface in response to the user interacting with the particular portion of the generative content via the particular type of input gesture.

18. The method of claim 17, wherein determining the terms associated with the particular portion of the generative content includes:
determining that a semantic similarity between the terms provided in the generative content satisfies a threshold similarity.

19. The method of claim 17, further comprising:
generating the prompt based on the terms and a previous prompt that was executed to
generate the generative content provided at the display interface,
wherein the prompt is executed using the one or more generative models.

20. The method of claim 19, wherein the prompt is further generated based on contextual data and/or personal knowledge graph information associated with the user.
